(19) United States
(12) Patent Application Publication
(10) Pub. No.: US 2016/0239855 A1
(43) Pub. Date: Aug. 18, 2016

(54) SYSTEM AND METHOD FOR POST-PROCESSING DEMAND FORECASTS

(71) Applicant: Wal-Mart Stores, Inc., Bentonville, AR (US)

(72) Inventors: Huijun Feng, San Francisco, CA (US); Ashin Mukherjee, Mountain View, CA (US)

(73) Assignee: Wal-Mart Stores, Inc., Bentonville, AR (US)

(21) Appl. No.: 14/624,054

(22) Filed: Feb. 17, 2015

(51) Int. Cl. G06Q 30/02; G06Q 10/08

(52) U.S. Cl. CPC G06Q 30/0202; G06Q 10/087

(57) ABSTRACT

A system and method for post-processing demand forecasts is presented. A forecast for a set of stock keeping units (SKUs) is received. Thereafter, a series of adjustments is are performed on the forecast. One adjustment involves determining how often orders are fulfilled by a drop ship vendor and adjusting a forecast to adjust for the fact that a portion of the forecast will never need to be ordered and stored at the retailer's warehouses. Another adjustments involves determining if there is a parent SKU the contains multiple child SKUs and adjusting accordingly. Another adjustment involves determining in there are any bundle SKUs that could be added to an individual SKU's forecast. Another adjustment involves adjusting a forecast based on a special buy. Another adjustment involves removing possibly dead items. Other embodiments are also disclosed herein.

### TECHNICAL FIELD

This disclosure relates generally to forecasting, and relates more particularly to demand forecasting for a retail business.

### BACKGROUND

A retail business typically needs to stock items in a warehouse or store in order to sell the items. Storing too few of a particular item can be undesirable because if the item is sold out, then the retail business is not able to sell the item until it is in stock again. Storing too many of a particular item also can be undesirable because the amount of space in a warehouse or store is finite—storing too many of an item that does not sell takes away space from items that do sell. Therefore, it would be desirable to have a system that can more accurately forecast the sales of items for a retailer or distributor.

### BRIEF DESCRIPTION OF THE DRAWINGS

To facilitate further description of the embodiments, the following drawings are provided in which:

FIG. 1 illustrates a front elevation view of a computer system that is suitable for implementing an embodiment of the system;

FIG. 2 illustrates a representative block diagram of an example of the elements included in the circuit boards inside a chassis of the computer system of FIG. 1;

FIG. 3 is a flowchart illustrating the operation of a method for post-processing a demand forecast;

FIGS. 4A-4B illustrate an exemplary sales graph of a stock keeping unit;

FIG. 5 is a flowchart illustrating the operation of a method for post-processing a demand forecast;

FIG. 6 is a flowchart illustrating the operation of a method for post-processing a demand forecast;

FIG. 7 is a flowchart illustrating the operation of a method for post-processing a demand forecast;

FIG. 8 is a graph illustrating an exemplary demand forecast;

FIG. 9 is a flowchart illustrating the operation of a method for post-processing a demand forecast;

FIG. 10 is a block diagram illustrating a system capable of performing a method for post-processing a demand forecast;

FIG. 11 is a block diagram illustrating a system capable of performing a method for post-processing a demand forecast;

FIG. 12 is a block diagram illustrating a system capable of performing a method for post-processing a demand forecast;

FIG. 13 is a block diagram illustrating a system capable of performing a method for post-processing a demand forecast; and

FIG. 14 is a block diagram illustrating a system capable of performing a method for post-processing a demand forecast.

For simplicity and clarity of illustration, the drawing figures illustrate the general manner of construction, and descriptions and details of well-known features and techniques might be omitted to avoid unnecessarily obscuring the present disclosure. Additionally, elements in the drawing figures are not necessarily drawn to scale. For example, the dimensions of some of the elements in the figures might be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but might include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements can be electrically coupled together, but not be mechanically or otherwise coupled together. Coupling can be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

In one embodiment, a method can comprise: receiving a demand forecast for a set of SKUs for a retailer; for each SKU in the set of SKUs, determining a percentage of previous orders fulfilled by a drop ship vendor; aggregating the percentage of previous orders fulfilled by the drop ship vendor with previous data to create an own percentage for each SKU in the set of SKUs; modifying the demand forecast using the own percentages; and ordering inventory for the retailer based on the modified demand forecast for each SKU in the set of cluster of SKUs.

In one embodiment, a system can comprise: a user input device; a display device; one or more processing modules; and one or more non-transitory storage modules storing computing instructions configured to run on the one or more processing modules and perform the acts of: receiving a demand forecast for a set of SKUs for a retailer; for each SKU in the set of SKUs, determining a percentage of previous orders fulfilled by a drop ship vendor; aggregating the percentage of previous orders fulfilled by the drop ship vendor with previous data to create an own percentage for each SKU in the set of SKUs; modifying the demand forecast using the own percentages; and ordering inventory for the retailer based on the modified demand forecast for each SKU in the set of cluster of SKUs.

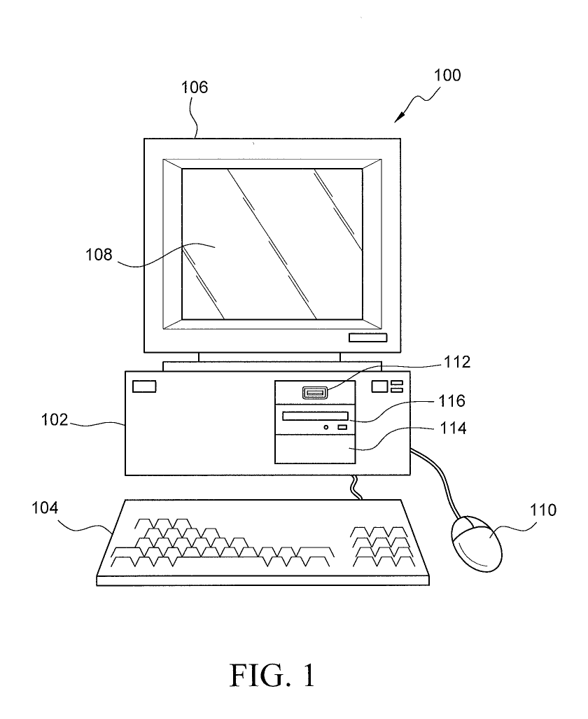

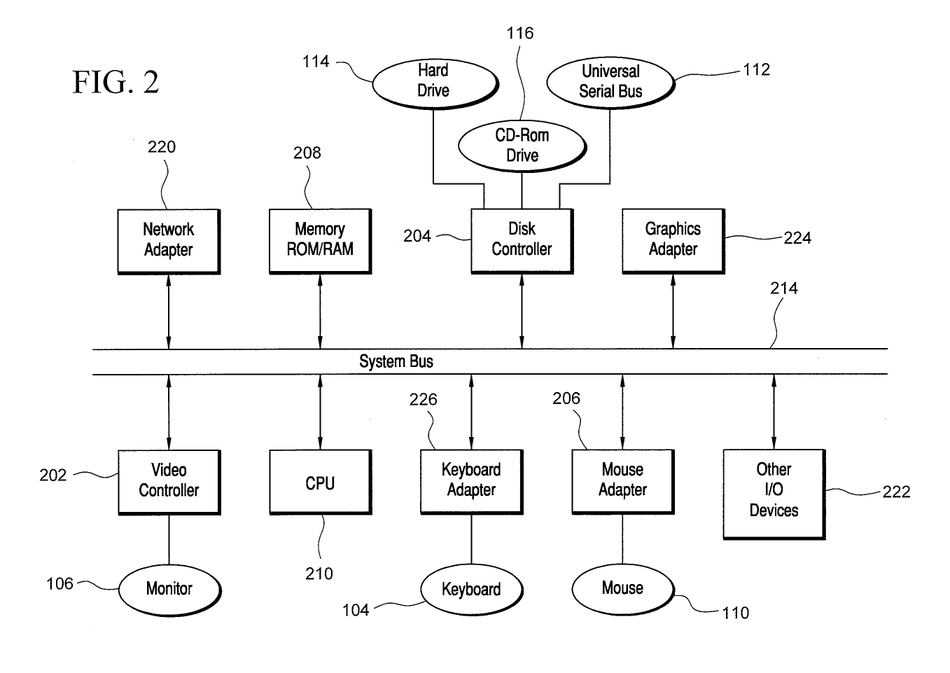

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage modules described herein. As an example, a different or separate one of a chassis 102 (and its internal components) can be suitable for implementing part or all of one or more embodiments of the techniques, methods, and/or systems described herein. Furthermore, one or more elements of computer system 100 (e.g., a refreshing monitor 106, a keyboard 104, and/or a mouse 110, etc.) can also be appropriate for implementing part or all of one or more embodiments of the techniques, methods, and/or systems described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 can comprise (i) volatile (e.g., transitory) memory, such as, for example, read only memory (ROM) and/or (ii) non-volatile (e.g., non-transitory) memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. The memory storage module(s) of the various embodiments disclosed herein can comprise memory storage unit 208, an external memory storage drive (not shown), such as, for example, a USB-equipped electronic memory storage drive coupled to universal serial bus (USB) port 112′ (FIGS. 1-2), hard drive 114 (FIGS. 1-2), CD-ROM and/or DVD drive 116 (FIGS. 1-2), a floppy disk drive (not shown), an optical disc (not shown), a magneto-optical disc (now shown), magnetic tape (not shown), etc. Further, non-volatile or non-transitory memory storage module(s) refer to the portions of the memory storage module(s) that are non-volatile (e.g., non-transitory) memory.

In various examples, portions of the memory storage module(s) of the various embodiments disclosed herein (e.g., portions of the non-volatile memory storage module(s)) can be encoded with a boot code sequence suitable for restoring computer system 100 (FIG. 1) to a functional state after a system reset. In addition, portions of the memory storage module(s) of the various embodiments disclosed herein (e.g., portions of the non-volatile memory storage module(s)) can comprise microcode such as a Basic Input-Output System (BIOS) operable with computer system 100 (FIG. 1). In the same or different examples, portions of the memory storage module(s) of the various embodiments disclosed herein (e.g., portions of the non-volatile memory storage module(s)) can comprise an operating system, which can be a software program that manages the hardware and software resources of a computer and/or a computer network. The BIOS can initialize and test components of computer system 100 (FIG. 1) and load the operating system. Meanwhile, the operating system can perform basic tasks such as, for example, controlling and allocating memory, prioritizing the processing of instructions, controlling input and output devices, facilitating networking, and managing files. Exemplary operating systems can comprise one of the following: (i) Microsoft® Windows® operating system (OS) by Microsoft Corp. of Redmond, Wash., United States of America, (ii) Mac® OS X by Apple Inc. of Cupertino, Calif., United States of America, (iii) UNIX® OS, and (iv) Linux® OS. Further exemplary operating systems can comprise one of the following: (i) the iOS® operating system by Apple Inc. of Cupertino, Calif., United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, Calif., United States of America, (v) the Windows Mobile™ operating system by Microsoft Corp. of Redmond, Wash., United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processing modules of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smart phone. In certain additional embodiments, computer system 100 may comprise an embedded system.

Forecasting is a key problem encountered in inventory planning for retailers and distributors. In order to buy inventory in advance, retailers or distributors would like an estimate of the number of units a distinct item for sale (also known as a stock keeping unit or a “SKU”) is going to sell in a certain time period. To clarify the difference between an item and a SKU, an item might be, for example, an iPad. But each specific configuration of the iPad (screen size, memory size, color, radio, and the like) is a different SKU. Each SKU typically has a unique identifier. Buying fewer quantities of a SKU than is needed leads to lost sales opportunities, hence lower revenue, because items that could have been sold were not in stock. Buying too many of a particular SKU units also can lead to lost sales opportunities because the cost of buying the unused inventory might not be compensated for by income from other sales to customers and can lead to lost opportunity costs (e.g., items that do not sell occupying space in a warehouse or store in place of items that could have been sold).

In general, a retailer or distributor wants to forecast the number of units it will sell so it can accurately purchase the units on a timely basis. One method of forecasting examines past sales of an item. Past sales can reveal both local level and seasonal patterns. Local level patterns refer to sales in the recent past, as sales of a certain SKU in the recent past can be important in forecasting future sales. Seasonality refers to periodic events that can influence sales. Seasonality can refer both to general seasonality (e.g., sales might be higher during the autumn because of the holiday season), and to product seasonality (e.g., some products are generally used only during certain times of the year.) For example, swimwear might be more popular in the summer, while Christmas decorations are more popular in the fall and winter.

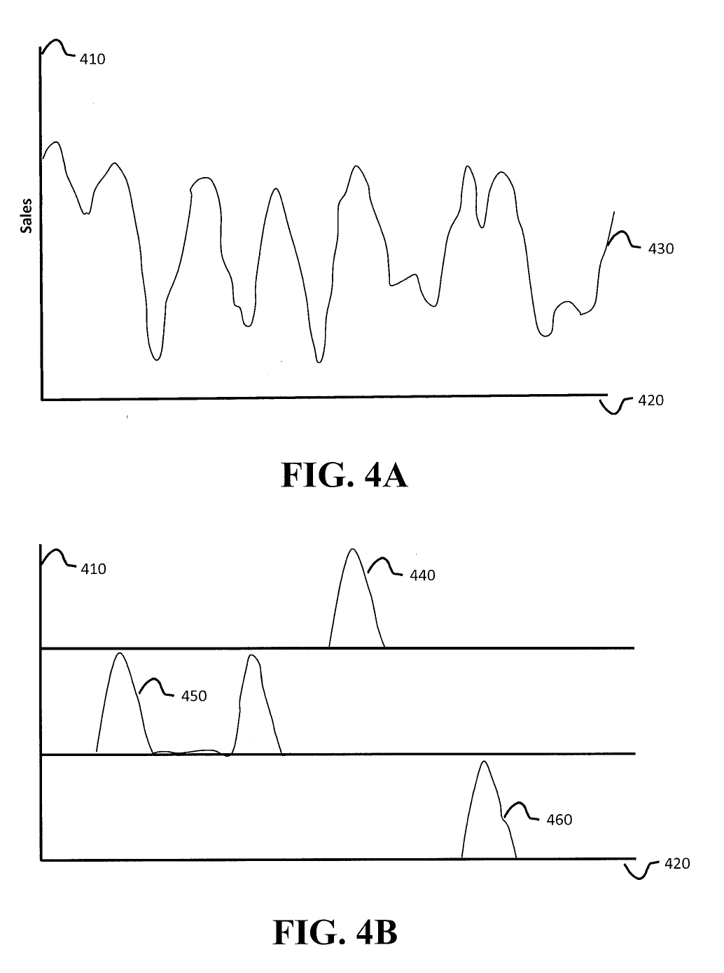

With reference to FIG. 4A, a graph illustrating the sales of an exemplary product is illustrated. X-axis 420 is the time period for the sales. For example, FIG. 4A could be an annual graph, and each time period is weekly sales. In another embodiment, FIG. 4A could be a multi-year graph, and each time period could be monthly sales. Other combinations are also possible.

Y-axis 410 is the range of values for sales. Data series 430 represents the sales for each time period represented by X-axis 420. Y-axis 410 can be in a variety of different formats. In some embodiments, Y-axis 410 can represent actual sales. In some embodiments, Y-axis 410 can represent sales rankings. Using rankings as opposed to actual sales might result in more reliable and accurate data in some embodiments. For modeling purposes, two time-series might be considered similar if they rise and fall in unison. A rank correlation metric such as a Pearson correlation or a Spearman correlation can be used to measure similarity between time-series. For display purposes, Y-axis 410 can be linear or logarithmic.

As described above, a retailer would take data such as that illustrated in FIG. 4A and use the data to predict future sales. If the graph is relatively periodic, the retailer can forecast that more of the sales would occur during a certain time of the year and that fewer sales would occur during other times of the year. A few situations can occur that can make the use of such data to predict future sales difficult for some SKUs. For example, a possible situation can occur with electronic commerce (“eCommerce”) retailers. Because eCommerce retailers generally store more SKUs than brick and mortar stores, there might not be enough sales data to model each SKU separately. In addition, eCommerce retailers often stock SKUs that are short-lived or have erratic data. For example, some eCommerce retailers have SKUs that sell out quickly, and there exists a time period where there is no data. In addition, there are SKUs that are short-lived, and thus there might not be available seasonal data from a previous year. Exemplary short-lived SKUs can include clothing (because of fashion trends, some items of clothing are sold only for a single season) and electronics (some forms of electronics, such as cell phone and TVs, are updated regularly, so a particular SKU might not have existed a year ago.)

FIG. 4B illustrates three different SKUs that have such situations. The same X-axis 420 and Y-axis 410 that are present in FIG. 4A are also present in FIG. 4B. Data series 440, data series 450, and data series 460 represent the sales of three different items. Data series 440 has incomplete data. Sales are present for only a very short time period, with no sales before or after that time period. This type of data series can be indicative of a short-lived item. Because the item had sales only for a very short-period of time, a popular but short-lived item might be indicative of a product that is no longer made. Data series 450 has two sales spikes, with a period of zero or otherwise low sales in between the sales spikes. Such a data series might be indicative of an item that could not keep up with demand (between the two spikes), and is no longer being made. Or such a data series might be indicative of a seasonal item (explaining the sales spikes) that is no longer being made (explaining the lack of data after the second sales spike). Data series 460 is similar to data series 440 in that it has only a single spike. However, while data series 440 is similar to data series 430 in that a peak for data series 430 roughly coincides with a peak of data series 440, data series 460 has a peak that roughly coincides with a trough of data series 430. This fact can indicate both that the item in data series 460 is a short-lived item and that its sales do not correlate well with the item represented by data series 430.

There are several different methods that can be used to generate demand forecasts for SKUs. Some methods involve placing a SKU in a cluster of SKUs and generating a forecast for the cluster of SKUs. Thereafter, one can use the forecast to order an appropriate number of the SKUs for a retailer or distributor. Other methods also can be used.

After the creation of the forecast, there might be inaccuracies that should be corrected before the forecast is turned into an order. An example of such an inaccuracy includes a parent/child problem.

The parent/child problem can occur if a forecast is generated for a set of SKUs that can be ordered only in a particular manner. A retailer or distributor typically orders SKUs from a supplier. The supplier provides the SKUs to the retailer in a certain manner that, in some cases, might not be changed. An example of this is quantity. A supplier may supply goods to a retailer in a large number that cannot be divided. For example, a retailer might not be able to purchase a single bottle of a particular type shampoo from a supplier. The supplier might provide that shampoo only in a box with 20 bottles of shampoo. In such a situation, a retailer cannot order 30 bottles of shampoo from the supplier, the retailer has to order either a single box with 20 bottles of shampoo or two boxes with a total of 40 bottles of shampoo. Once the retailer receives the box(es) of 20 bottles of shampoo, the retailer will typically offer them for sale in single quantities, not in batches of 20 in this example.

In such a situation, the retailer will have to round the forecast to the nearest quantity of 20. There can be several methods of rounding. A rounding could be to the nearest quantity of 20, such that 29 would round down to 20 and 31 would round up to 40. There could be a threshold value—above the threshold value, quantities are rounded up, and below the threshold, quantities are rounded down. For example, if the threshold were set at 5 above a quantity of 20, a forecast of 24 would be rounded down to 20, while a forecast of 25 would be rounded up to 40. The quantity could always round up, such that even a forecast of 21 will result in an order of 40 from the supplier. The quantity could always round down, such that even a forecast of 39 would round down to 20.

Another type of parent/child problem could be that a supplier might provide a SKU to a retailer packaged with other SKUs. Some products might be provided to a retailer with related, but different items. For example, the supplier might provide umbrellas to a retailer in a box of 20. However, that box of 20 umbrellas might contain 10 black umbrellas, 5 red umbrellas, and 5 black/white umbrellas. Each of those umbrellas would be a different SKU and would be separately forecast. The box of umbrellas itself however also is a separate SKU. In such a situation, the “parent” would be considered the box of 20 various umbrellas. The “children” would be considered each of the three types of umbrellas.

There are several possible solutions to such a situation. In some embodiments, the forecast for each of the children SKUs would be added to together to determine a forecast for the total number of children SKUs. Thereafter, the forecast for the total number of children SKUs is treated in a manner similar to that described above. That is, the total order can be rounded up or down as desired to result in an order from the supplier. For forecasting purpose, one would order the proper number of parent SKUs.

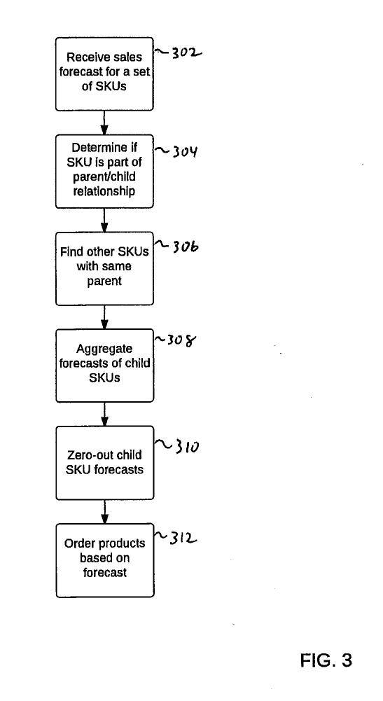

A flowchart illustrating the operation of a method 300 of adjusting a demand forecast is presented in FIG. 3. Method 300 is merely exemplary and is not limited to the embodiments presented herein. Method 300 can be employed in many different embodiments or examples not specifically depicted or described herein. In some embodiments, the procedures, the processes and/or the activities of method 500 can be performed in the order presented. In other embodiments, the procedures, the processes, and/or the activities of method 300 can be performed in any other suitable order. In still other embodiments, one or more of the procedures, the processes, and/or the activities of method 300 can be combined or skipped. In some embodiments, method 300 can be implemented by computer system 100 (FIG. 1).

A forecast for a set of SKUs is received (block 302). The forecast is typically a demand forecast—that is, a forecast of the consumer's demand for each SKU. It is determined if the SKU is a “child” of a parent/child relationship (block 304). If so, other SKUs are found that belong to the same “parent” SKU (block 306). Thereafter, the forecasts for the child SKUs are aggregated together and associated with the parent SKU (block 308). The forecast for the child SKUs are zeroed out (block 310). An order for the parent SKU can then be generated (block 312).

In some embodiments, the order for the parent SKU can be determined by the highest number of items forecast. For example, there might be a situation where 100 black umbrellas are forecast, 70 red umbrellas are forecast, but only 30 black/white umbrellas are forecast. That is a total of 200 umbrellas, so some embodiments might order enough umbrellas to result in 200 umbrellas. However, of those 200 umbrellas ordered, 100 would be black, 50 would be red, and 50 would be black/white. In some embodiments, instead of ordering enough umbrellas to cover the total umbrellas ordered, the order would reflect the 70 red umbrellas forecast. Such an order would include 140 black umbrellas, 70 red umbrellas, and 70 black/white umbrellas. However, it might not be desirable to order such an excess quantity of umbrellas (280 ordered even though 200 are forecast to be sold). Therefore, the order might remain at 200 total umbrellas, with the retailer hoping that consumers might be persuaded to buy black/white umbrellas if the red umbrellas sell out. In some situations, the retailer/distributor might not know the distribution of children in the parent. In such a situation, the retailer would merely add the forecast for each of the children to determine how many of the parent to order.

Another situation that can be encountered is a retailer/distributor's use of drop shipping. In a typical brick and mortar business model, when a customer purchases goods from a retailer, the good is physically located at the retailer. In an electronic commerce (eCommerce) business model, using a warehouse, a customer purchases goods from a retailer's website or mobile app. Thereafter, the ordered goods are shipped from the retailer's warehouse to the customer.

The goods in the warehouse were ordered from a different vendor and stocked in the retailer's warehouse. In some situations, however, a retailer may use drop shipping. In drop shipping, the retailer may have a relationship with a drop ship vendor such that, when a good is ordered from a retailer, the good is shipped directly from the drop ship vendor to the customer, without the need for the retailer to store the good in its warehouse. Such a relationship might be desirable for several reasons. For example, the drop ship vendor does not need to incur the expense of operating a website or attracting customers and the retailer does not need to incur the expense of storing goods in a warehouse until the goods are ordered.

In certain situations, a retailer uses both a warehouse system and drop shipping for certain items. There can be several advantages to such a setup. For example, sudden, unexpected demand might be easier to deal with because a portion of the ordered goods need not be purchased and stored in a warehouse beforehand. Such a setup also can deal with supplier problems, because the supply of goods is not limited to a single source. There might be geographic reasons for such a relationship. For example, a retailer's warehouse might be located in the Pacific time zone of the United States. The vendor's warehouse might be located in the Eastern time zone. The retailer might desire to use the drop ship vendor to fulfill orders destined for the east coast of the United States and use its own warehouse to fulfill orders in the remainder of the United States.

However, such a setup might make it more difficult for forecasting purposes. If 100 of a certain good is forecast to be sold, such a forecast could result in 100 of that good being ordered and stored in a warehouse, if the good is always kept in a retailer's warehouse. But if a portion of the goods is stored in the retailer's warehouse and the remainder is shipped from a drop ship vendor, such an arrangement should be taken into account when creating a forecast.

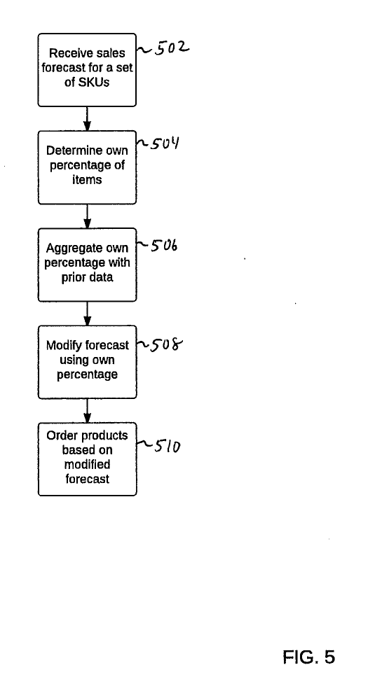

A flowchart illustrating the operation of a method 500 of adjusting a demand forecast is presented in FIG. 5. Method 500 is merely exemplary and is not limited to the embodiments presented herein. Method 500 can be employed in many different embodiments or examples not specifically depicted or described herein. In some embodiments, the procedures, the processes and/or the activities of method 500 can be performed in the order presented. In other embodiments, the procedures, the processes, and/or the activities of method 500 can be performed in any other suitable order. In still other embodiments, one or more of the procedures, the processes, and/or the activities of method 500 can be combined or skipped. In some embodiments, method 500 can be implemented by computer system 100 (FIG. 1).

A forecast for a SKU is received (block 502). In some embodiments, before a forecast is used to create an order, the retailer first determines the past percentage of orders fulfilled from the retailer's warehouse versus the percentage of orders fulfilled by a drop ship vendor. This percentage might be termed an “own percentage.” This own percentage calculation can be performed by analyzing data from previous time periods. In some embodiments, the time periods are weekly, and four time periods are analyzed. In some embodiments, the time periods are bi-weekly. Other embodiments can use other lengths and numbers of time periods. Any length and number of time periods can be used.

There can be several different methods of calculating an own percentage. In some embodiments, for each time period and for each SKU, the percentage of items shipped fulfilled by the retailer and the percentage of items shipped fulfilled by a drop ship vendor is determined (block 504). The percentages are aggregated with prior data (block 506). For example, the data might be weekly data, and there might be four weeks of data to be aggregated. Thereafter, this aggregated percentage (the “own percentage”) can be used to adjust the forecast. For example, a forecast might be that 100 of a certain SKU will be sold within a particular time period. However, if the retailer's history showed that 60% of that SKU sold by the retailer is from the warehouse and 40% of that SKU was fulfilled by a drop ship vendor, then ordering 100 of that SKU would result in too many of that SKU being ordered for storage in the retailer's warehouse. Thus, an embodiment adjusts the forecast based on the own percentage. In this case, because only 60% of the SKU sold by the retailer actually comes from the retailer's warehouse, the retailer needs to order only 60 of that SKU to fill the expected 100 orders. After the own percentage is calculated, the forecast is modified using the own percentage to determine a quantity to order (block 508). An order can then be placed with the proper quantities that reflect the percentage of items to be warehoused and the percentage of items to be fulfilled by a drop ship vendor (block 510).

The particulars of calculating the own percentage might differ in certain situations. The own percentage can be modeled as a Bernoulli distribution with success probability p being equal to the probability of fulfilling an order for a SKU from the retailer's warehouse. In such a case, the probability q is the probability of fulfilling an order from the drop ship vendor and would be calculated as q=1−p. The expected value of such a Bernoulli distribution is E(x)=p.

The conjugate prior probability distribution for a Bernoulli distribution is a beta distribution of two parameters a and b. This can be expressed as beta (a, b). An average percentage of a SKU within the set of SKUs being fulfilled by the drop ship vendor is represented by

$$\frac{b}{a + b} .$$

An average percentage of a SKU within the set of SKUs being fulfilled by the retailer's warehouse is represented by

$$\frac{a}{a + b} .$$

For each time t, the parameters can be updated as follows:

aₜ=aₜ₋₁+Oₜ₋₁

bₜ=bₜ₋₁+Dₜ₋₁

Where Oₜ₋₁ is actual data for SKUs being shipped from the retailer's warehouse for the previous time period and Dₜ₋₁ is the actual data for SKUs being shipped from the drop ship vendor during the previous time period.

The own percentage would then be expressed via the following expected value equation:

$${E}_{t} [ beta ( a , b ) ] = \frac{{a}_{t}}{{a}_{t} + {b}_{t}}$$

Another situation that a retailer might encounter that the retailer might want to deal with after receiving a forecast but before placing an order is the issue of bundles. A bundle is a single SKU, purchasable by a customer, that can contain multiple SKUs. There can be two different types of bundles, flexible bundles and inflexible bundles. A flexible bundle can be divided into the separate components of the bundle, each with a separate SKU, as well as an overall bundle with its own SKU. An exemplary flexible bundle can include a game console with an included game. A retailer might sell a bundle that includes both a game console (such as a Wii U) and a game (such as Mario Kart 8). However, that bundle also can be sold separately, such that a customer might buy a Wii U without the game or buy Mario Kart 8 without buying the console. Many types of flexible bundles are possible. For example, there might be a bundle including a memory card with a camera. There might be a bundle with fabric softener and detergent. There might be a bundle featuring a bicycle and a helmet.

An inflexible bundle is a bundle that is not sold separately. For example, a 2-piece bathing suit might have two components: a separate SKU for the top piece and a separate SKU for the bottom piece, and an overall SKU for the combination of the top and bottom pieces. However, because the retailer might never sell the top piece separately from the bottom piece, the retailer might not be interested in the forecasts for the top piece component or the bottom piece component.

The software generating the forecasts might not be aware of the existence of bundles, because bundles change frequently. Therefore, an embodiment operates to correct the forecasts by adjusting the forecasts to account for bundles.

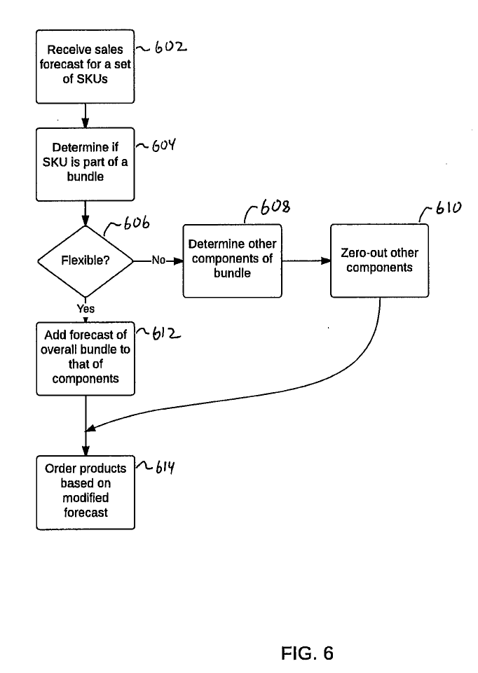

A flowchart illustrating the operation of a method 600 of modifying a forecast based on bundles is presented in FIG. 6. Method 600 is merely exemplary and is not limited to the embodiments presented herein. Method 600 can be employed in many different embodiments or examples not specifically depicted or described herein. In some embodiments, the procedures, the processes and/or the activities of method 600 can be performed in the order presented. In other embodiments, the procedures, the processes, and/or the activities of method 600 can be performed in any other suitable order. In still other embodiments, one or more of the procedures, the processes, and/or the activities of method 600 can be combined or skipped. In some embodiments, method 600 can be implemented by computer system 100 (FIG. 1).

A forecast for a SKU is received (block 602). It is then determined if the SKU is part of a bundle (block 604). If the SKU is part of a bundle, it is determined if the bundle is an inflexible bundle or a flexible bundle (block 606). If the SKU is a component of an inflexible bundle, the SKUs for the other components of the inflexible bundle are identified, along with an overall SKU for the inflexible bundle (block 608). The forecasts for the components of the inflexible bundle are ignored, and only the forecast for the overall inflexible bundle is forwarded for ordering purposes (block 610).

For flexible bundles, the forecast for the overall bundle SKU can be added to the forecast for the individual components of the SKU (block 612). For example, if the forecasting software projects 1,000 orders of the Wii U, 500 orders of the Mario Kart 8 game, and 2,000 orders of the Wii U+Mario Kart 8 bundle, the orders are combined such that the forecast is then for 3,000 orders of the Wii U (1,000 for the Wii U alone+2,000 for the bundle) and 2,500 orders of Mario Kart 8 (500 for Mario Kart 8 alone+2,000 for the bundle). An order can then be made using the adjusted forecasts (block 614).

Another situation that a retailer might encounter that the retailer might want to deal with after receiving a forecast but before placing an order is the issue of holiday items or special buys. As is well known, the holiday season is often a time period of great sales in many parts of the world. The holiday season has big shopping events such as Black Friday and Cyber Monday, leading up to gift giving holidays such as Hanukkah and Christmas. As a part of those shopping events, retailers often have sales, featuring their most publicized and biggest discounts of the year.

Because of the size and publicity of the sales, the generated forecasts for the most publicized items might not be accurate. For example, a television (TV) that is normally $1200 might be on sale for $650. Moreover, that TV's sale price might be publicized as a part of a large advertising campaign. Thus, more sales of that TV will likely occur than has been forecast.

A manual override of the sales can be performed by a marketing division of a retailer to make an initial order of those TVs. However, the manual override might not be sufficient for the retailer. For example, a warehouse might need to be prepared to store the large number of TVs. But the warehouse typically prepares warehouse space based on the forecast instead of the order from the marketing division. So the forecast itself has to be changed, not just the order. In addition, a large sale will often produce residual sales even after the biggest discount is over.

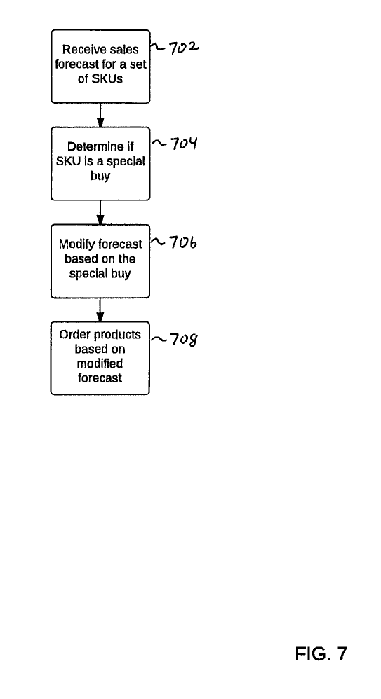

A flowchart illustrating the operation of a method 700 of modifying a forecast based on special buys is presented in FIG. 7. Method 700 is merely exemplary and is not limited to the embodiments presented herein. Method 700 can be employed in many different embodiments or examples not specifically depicted or described herein. In some embodiments, the procedures, the processes and/or the activities of method 700 can be performed in the order presented. In other embodiments, the procedures, the processes, and/or the activities of method 700 can be performed in any other suitable order. In still other embodiments, one or more of the procedures, the processes, and/or the activities of method 700 can be combined or skipped. In some embodiments, method 700 can be implemented by computer system 100 (FIG. 1).

A forecast for a SKU is received (block 702). It is then determined if the SKU is a part of special buy or holiday sale (block 704). This can be accomplished in a number of different manners. For each SKU, the number of items ordered can be compared to the number of items forecast. A SKU that has a large disparity between the forecast and the orders can be an indication of a SKU that is part of a special buy. In some embodiments, when one submits a special order for extra units of a SKU, that special order can be noted and automatically indicate that the SKU is part of a special buy. After it is determined that a SKU is part of a special buy, the forecast for the SKU can be adjusted for the special buy (block 706). More particularly, the forecast can be adjusted for time period past the initial sales price.

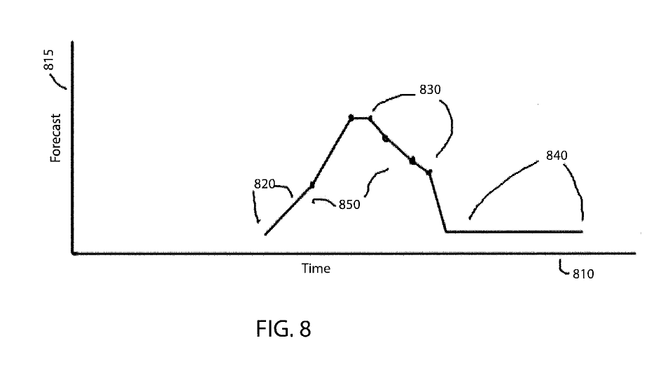

A Black Friday or Cyber Monday sale is typically short lived. The lowest price might exist for only a few hours. However, even after the large sale is over, there still might be a lower price. For example, the $1200 TV that was reduced to $650 for a Cyber Monday sale lasting 3 hours might be on sale for $900 for another week. Moreover, with the prices for many items being reduced during the holiday season, sales in general will still be higher than during non-sale seasons. So the forecast might be adjusted to follow a sales curve similar to a sales curve that was forecast, just with a higher initial sales value. An example of this behavior is presented in FIG. 8. Therefore, after the forecast is adjusted, the forecast can be used to order items (block 708), as shown in FIG. 7.

FIG. 8 presents a graph of forecast sales over time. X-axis 810 represents the time. Y-axis 815 represents the number of units forecast to be sold for a certain time period. In FIG. 8, the data might be presented in weekly time periods. Thus, the graph represents forecast sales per week. Data series 850 is the graph of forecast sales per week. Data series 850 can be broken into three separate segments, 820, 830, and 840. During segment 820, the sales are forecast in a traditional manner, using various techniques such as clustering to produce an estimate for the number of sales of a particular SKU. During segment 830, there was an override—instead of the forecast number of sales, a higher number is being used because the particular SKU being graphed in FIG. 8 is part of a special buy. While the first data point of segment 830 was overridden because of the special buy, the remaining five data points of segment 830 were generated by an embodiment. These five data points are generated to follow the general curve of what was originally predicted by the forecasting software, but adjusted for the higher initial amount of items needed for the special buy. Segment 840 is for after the holiday sales period is over. During this segment, the forecast resumes the normal forecasting pattern.

Another situation that a retailer might encounter is the desire to reconcile “bottom-up” forecasting with “top-down” planning. Forecasts are generated in a “bottom-up” manner—that is, forecasts are generated at the item level, which then can be aggregated to categories, then departments, to an overall sales goal. However, sales goals generated by people are often the opposite. That is, “top-down” forecasts, in which management sets a sales goal, which is then broken down into departments, then categories, then individual items.

Forecasts are for demand. However, demand is not completely related to sales—they are negatively affected by out-of-stock items. Forecasters use auxiliary information to adjust forecasts, using business logic to determine that sales might be different than the generated forecast. Some useful sources of information include sales in recent past, item display status, SKU start date, end date (to identify SKUs that are going to be retired or archived) to infer the lifespan of the SKU, current inventory on-hand, and current inventory on-order. For example, it has been found that an item that has not had sales for the past six-weeks is unlikely to sell in the next six week period. These items can be termed “dead items.” Thus, even though the forecast is for a non-zero amount, an embodiment can change the forecast to account for the decreased likelihood of sales.

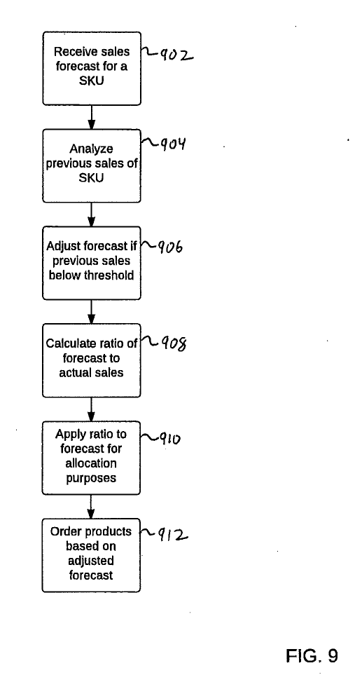

A flowchart illustrating the operation of a method 900 of modifying a forecast is presented in FIG. 9. Method 900 is merely exemplary and is not limited to the embodiments presented herein. Method 900 can be employed in many different embodiments or examples not specifically depicted or described herein. In some embodiments, the procedures, the processes and/or the activities of method 900 can be performed in the order presented. In other embodiments, the procedures, the processes, and/or the activities of method 900 can be performed in any other suitable order. In still other embodiments, one or more of the procedures, the processes, and/or the activities of method 900 can be combined or skipped. In some embodiments, method 900 can be implemented by computer system 100 (FIG. 1).

A forecast for a SKU is received (block 902). Previous sales for a SKU are analyzed to determine the sales for a predetermined time period (block 904). In some embodiments, the time period being analyzed is approximately the previous 6 weeks. In some embodiments, the time period being analyzed is approximately the previous 13 weeks (e.g., one quarter). If the number of actual sales is at or below a certain threshold, then the forecast can be adjusted (block 906). In some embodiments, the threshold can be very low, such as zero units. If the actual sales during a period is zero, then it has been shown, historically, that it is unlikely that there will be any further sales. Thus, even if the forecast is for a non-zero number of items to be sold, the forecast can be adjusted such that the new forecast remains zero. If an item was not published at a retailer's website in the past week and if it is not a new item, then the probability of that item selling in the near future decreases sharply. Therefore, the forecasts could be truncated without incurring extra error. Similarly, for items that are past or approaching its due date, one could use the current stock on hand and on-order inventory level to dynamically truncate the forecasts. Information such as recent historical sales, inventory position, item lifespan, and website display status can be considered “auxiliary information.”

Also calculated is the ratio between demand forecast and actual sales over a certain time period (block 908). This comparison might be done for a particular item, a particular group of items, the retailer as a whole, or the like. Thereafter, the ratio can be applied to the demand forecast for allocation purposes (910). For example, if it has been found that the sales of a particular retailer are approximately 80% of a demand forecast. In such a case, the allocation would be for 80% of the demand forecast. Allocation can be used to distribute inventory among distribution centers. A retailer might have more than one distribution center from which orders are shipped. Certain distribution centers can be faster at responding than others. Allocation can be used to place SKUs in various distribution centers. To continue the above example, if sales are approximately 80% of the demand forecast, then 80% of the forecast can be placed in faster distribution centers. Thereafter, the orders can be made based on the adjusted forecast (912).

While a variety of different methods have been described and illustrated above, it should be understood that the above-described methods can be used in conjunction with each other and in a variety of different orders. For example, in some embodiments, the procedure described with reference to FIG. 3 might be performed before the procedure described with reference to FIG. 5. In other embodiments, the procedure described with reference to FIG. 5 might be performed before the procedure described with reference to FIG. 3. In some embodiments, all of the above-described methods are performed. In other embodiments, only a subset of the above-described methods are performed.

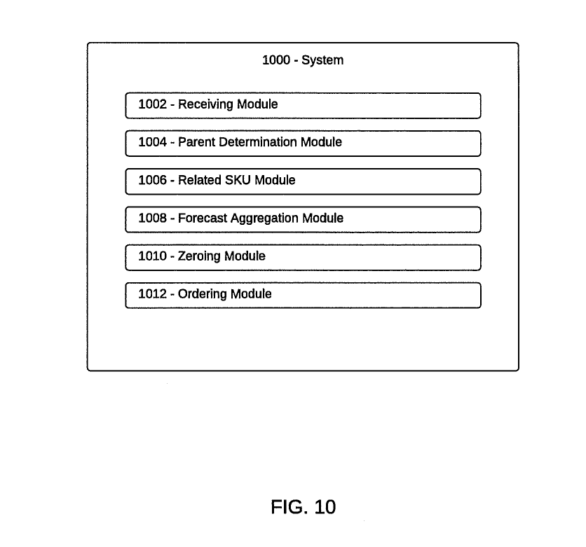

Turning ahead in the figures, FIG. 10 illustrates a block diagram of a system 1000 that is capable of performing disclosed embodiments. System 1000 is merely exemplary and is not limited to the embodiments presented herein. System 1000 can be employed in many different embodiments or examples not specifically depicted or described herein. In some embodiments, certain elements or modules of system 1000 can perform various procedures, processes, and/or acts. In other embodiments, the procedures, processes, and/or acts can be performed by other suitable elements or modules.

In a number of embodiments, system 1000 can include SKU receiving module 1002. In certain embodiments, SKU receiving module 1002 can perform block 302 (FIG. 3) of receiving a forecast for a set of SKUs.

In a number of embodiments, system 1000 can include parent determination module 1004. In certain embodiments, parent determination module 1004 can perform block 304 (FIG. 3) of determining if a SKU is in a parent/child relationship with another SKU.

System 1000 can include related SKU module 1006. In certain embodiments, related SKU module 1006 can perform block 306 (FIG. 3) of finding SKUs that belong to the same parent SKU.

System 1000 can include forecast aggregation module 1008. In certain embodiments, forecast aggregation module 1008 can perform block 308 of aggregating forecasts of the child SKUs.

System 1000 can include zeroing module 1010. In certain embodiments, zeroing module 510 can perform block 310 of zeroing out a forecast for the child SKUs.

System 1000 can include ordering module 1012. In certain embodiments, ordering module 1012 can perform block 312 of ordering products based on the aggregated forecast.

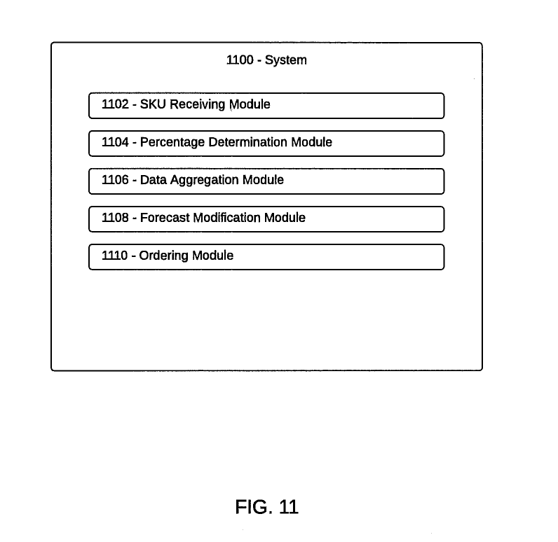

Turning ahead in the figures, FIG. 11 illustrates a block diagram of a system 1100 that is capable of performing disclosed embodiments. System 1100 is merely exemplary and is not limited to the embodiments presented herein. System 1100 can be employed in many different embodiments or examples not specifically depicted or described herein. In some embodiments, certain elements or modules of system 1100 can perform various procedures, processes, and/or acts. In other embodiments, the procedures, processes, and/or acts can be performed by other suitable elements or modules.

In a number of embodiments, system 1100 can include SKU receiving module 1102. In certain embodiments, SKU receiving module 1102 can perform block 502 (FIG. 5) of receiving a forecast for a set of SKUs.

In a number of embodiments, system 1100 can include percentage determination module 1104. In certain embodiments, percentage determination module 1104 can perform block 504 (FIG. 5) of determining a percentage of items shipped by a drop ship vendor.

System 1100 can include data aggregation module 1106. In certain embodiments, data aggregation module 1106 can perform block 506 (FIG. 5) of aggregating percentage data with prior data.

System 1100 can include forecast modification module 1108. In certain embodiments, forecast modification module 1108 can perform block 508 of modifying forecasts based on the aggregated data.

System 1100 can include ordering module 1110. In certain embodiments, ordering module 1110 can perform block 510 of ordering products based on the modified forecast.

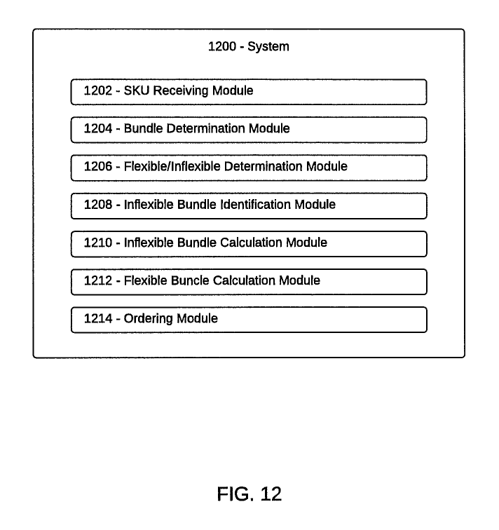

Turning ahead in the figures, FIG. 12 illustrates a block diagram of a system 1200 that is capable of performing disclosed embodiments. System 1200 is merely exemplary and is not limited to the embodiments presented herein. System 1200 can be employed in many different embodiments or examples not specifically depicted or described herein. In some embodiments, certain elements or modules of system 1200 can perform various procedures, processes, and/or acts. In other embodiments, the procedures, processes, and/or acts can be performed by other suitable elements or modules.

In a number of embodiments, system 1200 can include SKU receiving module 1202. In certain embodiments, SKU receiving module 1202 can perform block 602 (FIG. 6) of receiving a forecast for a set of SKUs.

In a number of embodiments, system 1200 can include bundle determination module 1204. In certain embodiments, bundle determination module 1204 can perform block 604 (FIG. 6) of determining if a SKU is part of a bundle.

System 1200 can include flexible/inflexible determination module 1206. In certain embodiments, flexible/inflexible determination module 1206 can perform block 606 (FIG. 6) of determining if the bundle is flexible or inflexible.

System 1200 can include inflexible bundle identification module 1208. In certain embodiments, inflexible bundle identification module 1208 can perform block 608 of identifying components of an inflexible bundle.

System 1200 can include inflexible bundle calculation module 1210. In certain embodiments, inflexible bundle calculation module 1210 can perform block 610 of modifying the forecast for inflexible bundle components.

System 1200 can include flexible bundle calculation module 1212. In certain embodiments, flexible bundle calculation module 1212 can perform block 612 of aggregating the forecast for the components of a flexible bundle.

System 1200 can include ordering module 1214. In certain embodiments, ordering module 1214 can perform block 614 of ordering products based on the modified forecast.

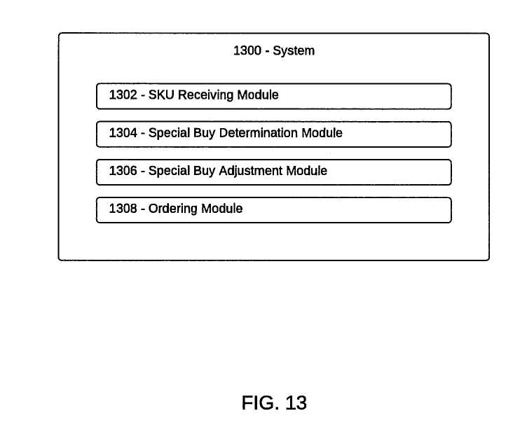

Turning ahead in the figures, FIG. 13 illustrates a block diagram of a system 1300 that is capable of performing disclosed embodiments. System 1300 is merely exemplary and is not limited to the embodiments presented herein. System 1300 can be employed in many different embodiments or examples not specifically depicted or described herein. In some embodiments, certain elements or modules of system 1300 can perform various procedures, processes, and/or acts. In other embodiments, the procedures, processes, and/or acts can be performed by other suitable elements or modules.

In a number of embodiments, system 1300 can include SKU receiving module 1302. In certain embodiments, SKU receiving module 1302 can perform block 702 (FIG. 7) of receiving a forecast for a set of SKUs.

In a number of embodiments, system 1300 can special buy determination module 1304. In certain embodiments, special buy determination module 1304 can perform block 704 (FIG. 7) of determining if a SKU is part of a special buy.

System 1300 can include special buy adjustment module 1306. In certain embodiments, special buy module 1306 can perform block 706 (FIG. 7) of adjusting a forecast based on a special buy determination.

System 1300 can include ordering module 1308. In certain embodiments, ordering module 1308 can perform block 708 (FIG. 7) of ordering products based on the adjusted forecast.

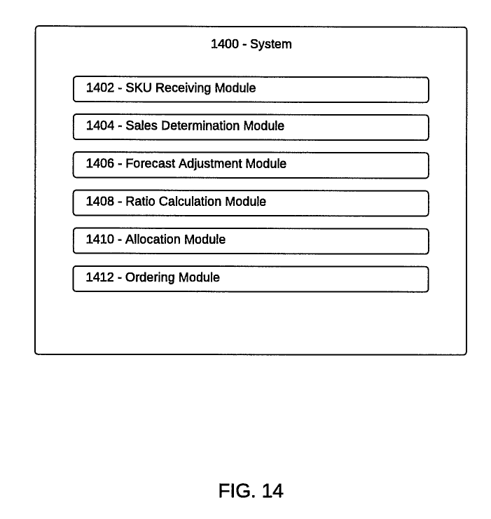

Turning ahead in the figures, FIG. 14 illustrates a block diagram of a system 1400 that is capable of performing disclosed embodiments. System 1400 is merely exemplary and is not limited to the embodiments presented herein. System 1400 can be employed in many different embodiments or examples not specifically depicted or described herein. In some embodiments, certain elements or modules of system 1400 can perform various procedures, processes, and/or acts. In other embodiments, the procedures, processes, and/or acts can be performed by other suitable elements or modules.

In a number of embodiments, system 1400 can include SKU receiving module 1402. In certain embodiments, SKU receiving module 1402 can perform block 902 (FIG. 9) of receiving a forecast for a set of SKUs.

In a number of embodiments, system 1400 can include sales determination module 1404. In certain embodiments, sales determination module 1404 can perform block 904 (FIG. 9) of determining previous sales of the SKU for a predetermined time period.

System 1400 can include forecast adjustment module 1406. In certain embodiments, forecast adjustment module 1406 can perform block 906 (FIG. 9) of adjusting a forecast to zero if previous sales fail to meet a threshold.

System 1400 can include ratio calculation module 1408. In certain embodiments, ratio calculation module 1408 can perform block 908 (FIG. 9) of determining a ratio between forecast and sales for the SKU.

System 1400 can include allocation module 1410. In certain embodiments, allocation module 1410 can perform block 910 (FIG. 9) of allocating products based on the ratio.

System 1400 can include ordering module 1412. In certain embodiments, ordering module 1412 can perform block 912 (FIG. 9) of ordering products based on an adjusted forecast.

Although the above embodiments have been described with reference to specific embodiments, it will be understood by those skilled in the art that various changes can be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-14 can be modified, and that the foregoing discussion of certain of these embodiments does not necessarily represent a complete description of all possible embodiments. For example, one or more of the procedures, processes, or activities of FIGS. 1-14 can include different procedures, processes, and/or activities and be performed by many different modules, in many different orders.

Replacement of one or more claimed elements constitutes reconstruction and not repair. Additionally, benefits, other advantages, and solutions to problems have been described with regard to specific embodiments. The benefits, advantages, solutions to problems, and any element or elements that can cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A method comprising:
receiving a demand forecast for a set of SKUs for a retailer;
for each SKU in the set of SKUs, determining a percentage of previous orders fulfilled by a drop ship vendor;
aggregating the percentage of previous orders fulfilled by the drop ship vendor with previous data to create an own percentage for each SKU in the set of SKUs;
modifying the demand forecast using the own percentages; and
ordering inventory for the retailer based on the modified demand forecast for each SKU in the set of cluster of SKUs.

2. The method of claim 1 wherein:
the own percentage is modeled as a Bernoulli distribution with a probability p equal to the probability of not fulfilling the order from the drop ship vendor and a probability q equal to the probability of fulfilling the order from the drop ship vendor; and
where q=1−p.

3. The method of claim 2 wherein:
a conjugate prior probability of the Bernoulli distribution is modeled via a beta distribution of two parameters a and b, where an average percentage of a SKU within the set of SKUs being fulfilled by the drop ship vendor is represented by b/(a+b).

4. The method of claim 3 wherein:
aggregating the percentage of previous orders fulfilled by the drop ship vendor with previous data comprises:
updating the parameters as follows:
aₜ=aₜ₋₁+Oₜ₋₁
bₜ=bₜ₋₁+Dₜ₋₁
where Oₜ₋₁ is actual data for SKUs within the set of SKUs being shipped from a warehouse of the retailer for a previous time period and where Dₜ₋₁ is the actual data for SKUs within the set of SKUs being shipped from the drop ship vendor during the previous time period.

5. The method of claim 1 further comprising:
for each SKU in the set of SKUs, determining if the SKU has a parent SKU;
if the SKU has a parent SKU, finding additional SKUs in the set of SKUs that have the same parent SKU; and
aggregating the demand forecasts for each SKU with the same parent SKU;
wherein ordering the inventory comprises:
ordering the inventory based on the aggregated demand forecast for each SKU in the set of SKUs that is associated with a parent SKU.

6. The method of claim 5 further comprising:
for each SKU with the same parent SKU changing the forecast for such SKU to zero.

7. The method of claim 1 further comprising:
for each SKU in the set of SKUs, determining if the SKU is available in a bundle with other SKUs;
if the SKU is available is so available, determining if the bundle is an inflexible bundle within the set of SKUs;
if the SKU bundle is inflexible, determining an overall bundle SKU for the SKU and one or more component SKUs of the overall bundle SKU, and changing the demand forecast for each of the one or more component SKUs to zero; and
if the bundle is a flexible bundle, for each component SKU within the set of SKUs of the bundle, add a demand forecast for the flexible bundle to a demand forecast for the component SKU of the flexible bundle;
wherein ordering the inventory comprises:
ordering inventory based on the modified demand forecast.

8. The method of claim 1 further comprising:
for each SKU in the set of SKUs, determining if the SKU is part of a special buy; and
adjusting the demand forecast to account for the special buy;
wherein ordering the inventory comprises:
ordering inventory based on the adjusted forecast.

9. The method of claim 8 wherein:
determining if the SKU is part of the special buy comprises comparing a number of orders for the SKU to a demand forecast for the SKU to determine if there is an increase in the number of orders; and
adjusting the demand forecast to account for the special buy comprises:
adding the increase in the number of orders for the SKU to create a baseline forecast for the SKU; and
creating a demand forecast for the SKU based on the baseline forecast.

10. The method of claim 1 further comprising:
for each SKU in the set of SKUs, using auxiliary information including recent historical sales, inventory position, item lifespan, and website display status to determine a criterion to classify the items that are most likely to sell;
calculating a ratio of an aggregated demand forecast to observed historical sales and using the ratio to scale the demand forecast for allocating the SKU; wherein:
the allocation is arranged to distribute inventory among a plurality of distribution centers; and
ordering the inventory comprises ordering the inventory based on an aggregated demand forecast for each cluster of SKUs.

11. A system comprising:
a user input device;
a display device;
one or more processing modules; and
one or more non-transitory storage modules storing computing instructions configured to run on the one or more processing modules and perform the acts of:
receiving a demand forecast for a set of SKUs for a retailer;
for each SKU in the set of SKUs, determining a percentage of previous orders fulfilled by a drop ship vendor;
aggregating the percentage of previous orders fulfilled by the drop ship vendor with previous data to create an own percentage for each SKU in the set of SKUs;
modifying the demand forecast using the own percentages; and
ordering inventory for the retailer based on the modified demand forecast for each SKU in the set of cluster of SKUs.

12. The system of claim 11 wherein:
the own percentage is modeled as a Bernoulli distribution with a probability p equal to the probability of not fulfilling the order from the drop ship vendor and a probability q equal to the probability of fulfilling the order from the drop ship vendor; and
where q=1−p.

13. The system of claim 12 wherein:
a conjugate prior probability of the Bernoulli distribution is modeled via a beta distribution of two parameters a and b, where an average percentage of a SKU within the set of SKUs being fulfilled by the drop ship vendor is represented by b/(a+b).

14. The system of claim 13 wherein:
aggregating the percentage of previous orders fulfilled by the drop ship vendor with previous data comprises:
updating the parameters as follows:
aₜ=aₜ₋₁+Oₜ₋₁
bₜ=bₜ₋₁+Dₜ₋₁
where Oₜ₋₁ is actual data for SKUs within the set of SKUs being shipped from a warehouse of the retailer for a previous time period and where Dₜ₋₁ is the actual data for SKUs within the set of SKUs being shipped from the drop ship vendor during the previous time period.

15. The system of claim 11 further comprising:
for each SKU in the set of SKUs, determining if the SKU has a parent SKU;
if the SKU has a parent SKU, finding additional SKUs in the set of SKUs that have the same parent SKU; and
aggregating the demand forecasts for each SKU with the same parent SKU;
wherein ordering the inventory comprises:
ordering the inventory based on the aggregated demand forecast for each SKU in the set of SKUs that is associated with a parent SKU.

16. The system of claim 15 further comprising:
for each SKU with the same parent SKU changing the forecast for such SKU to zero.

17. The system of claim 11 further comprising:
for each SKU in the set of SKUs, determining if the SKU is available in a bundle with other SKUs;
if the SKU is available is so available, determining if the bundle is an inflexible bundle within the set of SKUs;
if the SKU bundle is inflexible, determining an overall bundle SKU for the SKU and one or more component SKUs of the overall bundle SKU, and changing the demand forecast for each of the one or more component SKUs to zero; and
if the bundle is a flexible bundle, for each component SKU within the set of SKUs of the bundle, add a demand forecast for the flexible bundle to a demand forecast for the component SKU of the flexible bundle;
wherein ordering the inventory comprises:
ordering inventory based on the modified demand forecast.

18. The system of claim 11 further comprising:
for each SKU in the set of SKUs, determining if the SKU is part of a special buy; and
adjusting the demand forecast to account for the special buy;
wherein ordering the inventory comprises:
ordering inventory based on the adjusted forecast.

19. The system of claim 18 wherein:
determining if the SKU is part of the special buy comprises comparing a number of orders for the SKU to a demand forecast for the SKU to determine if there is an increase in the number of orders; and
adjusting the demand forecast to account for the special buy comprises:
adding the increase in the number of orders for the SKU to create a baseline forecast for the SKU; and
creating a demand forecast for the SKU based on the baseline forecast.

20. The system of claim 11 further comprising:
for each SKU in the set of SKUs, using auxiliary information including recent historical sales, inventory position, item lifespan, and website display status to determine a criterion to classify the items that are most likely to sell;
calculating a ratio of an aggregated demand forecast to observed historical sales and using the ratio to scale the demand forecast for allocating the SKU; wherein:
the allocation is arranged to distribute inventory among a plurality of distribution centers; and
ordering the inventory comprises ordering the inventory based on an aggregated demand forecast for each cluster of SKUs.
